(19) United States
(12) Patent Application Publication
(10) Pub. No.: US 2026/0278710 A1
(43) Pub. Date: Sep. 17, 2026

(54) Property Ownership Artificial Intelligence Agent

(71) Applicants: Mark Roden, Sherman Oaks, CA (US); Oded Noy, Los Angeles, CA (US); Ahmet Demirhan, Playa Vista, CA (US); Adam Siegel, Playa Vista, CA (US)

(72) Inventors: Mark Roden, Sherman Oaks, CA (US); Oded Noy, Los Angeles, CA (US); Ahmet Demirhan, Playa Vista, CA (US); Adam Siegel, Playa Vista, CA (US)

(73) Assignee: Commercial Real Estate Exchange, Inc., Playa Vista, CA (US)

(21) Appl. No.: 19/555,659

(22) Filed: Mar. 3, 2026

Related U.S. Application Data
(60) Provisional application No. 63/772,246, filed on Mar. 14, 2025.

(51) Int. Cl. G06Q 50/163; G06N 20/00

(52) U.S. Cl. CPC G06Q 50/163; G06N 20/00

(57) ABSTRACT

For identifying owners and synchronizing the owners with listing data, a method trains an ownership model and identifies contacts of property for owner identification. The method enriches the contacts and sorts the contacts. The method communicates with the contacts via an AI agent that employs the ownership model and communicates in natural language. The method stores the communications and evaluates the communications using the AI agent for owners and communication strategies. The method synchronizes the owners and contacts with the listing data. The method generates training data from the communications, the owners, and the communication strategies and fine tunes the ownership model using the training data. The method sends messages to the contacts using the ownership model.

### CROSS-REFERENCE TO RELATED APPLICATIONS

The application claims priority to U.S. Provisional Patent Application No. 63/772,246 entitled “Property Ownership Artificial Intelligence Agent” and filed on Mar. 14, 2025 for Mark Roden, which is incorporated herein by reference.

### BACKGROUND INFORMATION

The subject matter disclosed herein relates to Artificial Intelligence (AI) agents and more particularly relates to property ownership AI agents.

### BRIEF DESCRIPTION

A method for identifying owners and synchronizing the owners with listing data is disclosed. The method trains an ownership model and identifies contacts of property for owner identification. The method enriches the contacts and sorts the contacts. The method communicates with the contacts via an AI agent that employs the ownership model and communicates in natural language. The method stores the communications and evaluates the communications using the AI agent for owners and communication strategies. The method synchronizes the owners and contacts with the listing data. The method generates training data from the communications, the owners, and the communication strategies and fine tunes the ownership model using the training data. The method sends messages to the contacts using the ownership model. An apparatus and computer program product are also disclosed.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of property system;

FIG. 2A is a schematic block diagram illustrating one embodiment of property data;

FIG. 2B is a schematic block diagram illustrating one embodiment of contact data;

FIG. 2C is a schematic block diagram illustrating one embodiment of communication data;

FIG. 3 is a schematic block diagram illustrating one embodiment of system data;

FIG. 4A is a schematic block diagram illustrating one embodiment of a computer;

FIG. 4B is a schematic diagram illustrating one embodiment of a neural network;

FIGS. 5A-B are schematic flow chart diagrams illustrating one embodiment of a property ownership method;

FIG. 5C is a schematic flow chart diagram illustrating one embodiment of a model training method; and

FIG. 6 is a schematic flow chart diagram illustrating one embodiment of a property element extraction method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Go, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

“AI Agent System Technical Specification” is incorporated herein by reference.

The description of elements in each figure may refer to elements of proceeding figures. Like numbers refer to like elements in all figures, including alternate embodiments of like elements.

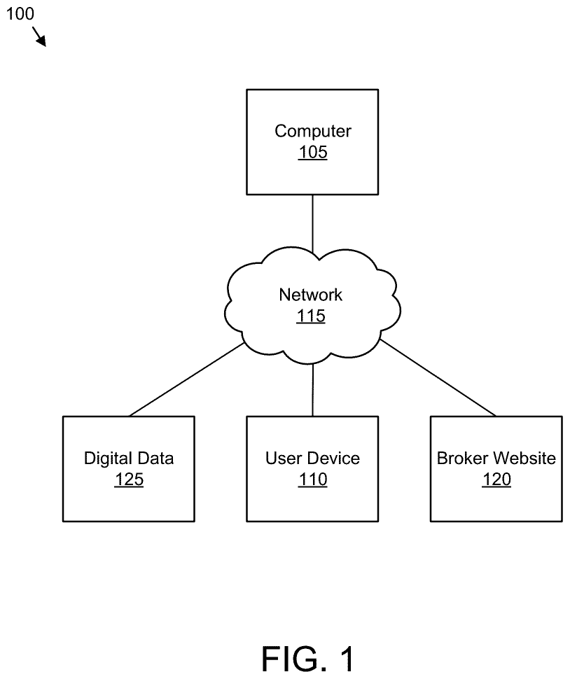

FIG. 1 is a schematic block diagram illustrating one embodiment of property system 100. In the depicted embodiment, the property system 100 includes a computer 105, a network 115, digital data 125, a user device 110, and a broker website 120. The computer 105 communicates through the network 115 with the digital data 125, the user device 110, and/or the broker website 120. The network 115 may be a telephone network, a mobile phone network, the Internet, and the like. The digital data 125 may include jurisdictional property records, real estate listings, and the like. The broker website 120 may list properties that are for sale.

The computer 105 may host a plurality of AI agents. The AI agents may communicate through the network 115 with the digital data 125, the user device 110, and/or the broker website 120. The AI agents may employ an ownership model as will be described hereafter. In one embodiment, the AI agents communicate with a contact via the user device 110. The contact may have information with regards to a property. The AI agent may communicate in natural language to query the contact regarding the property. As a result, the AI agent may cost effectively and efficiently add to information regarding ownership of the property. In addition, the AI agents may add to property information on a scale that is impossible for human agents. The organization and function of the AI agents is described hereafter.

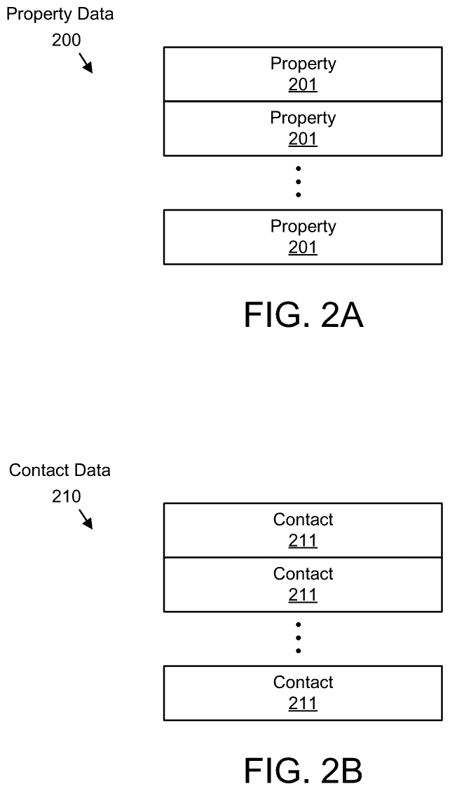

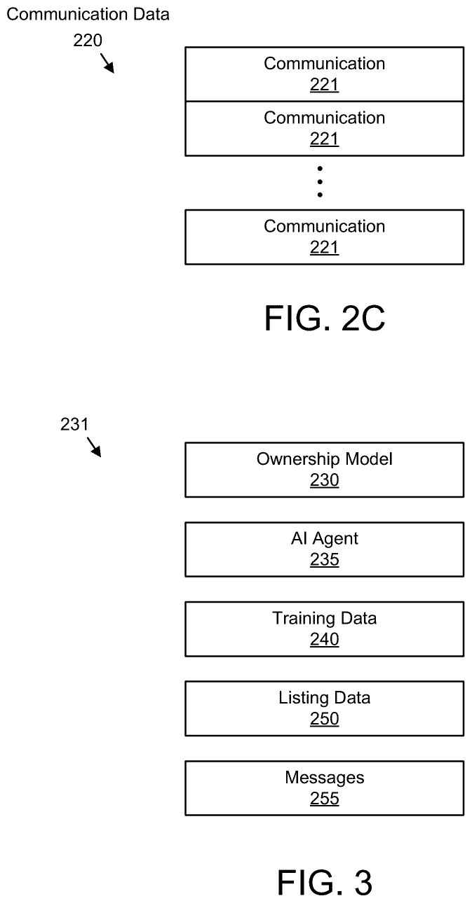

FIG. 2A is a schematic block diagram illustrating one embodiment of property data 200. The property data 200 may be organized as a data structure in a memory. In one embodiment, data described herein may be organized using a Kafka system. In the depicted embodiment, the property data 200 includes a plurality of properties 201. Each property 201 may comprise property elements that are included in but not limited to Table 1.

TABLE 1

Address
Size
Lot
Jurisdiction
Taxes
Trigger for Additional Communication

FIG. 2B is a schematic block diagram illustrating one embodiment of contact data 210. The contact data 210 may be organized as a data structure in a memory. In the depicted embodiment, the contact data 210 includes a plurality of contacts 211. Each contact 211 may comprise data that is included in but not limited to Table 2.

TABLE 2

Owner Propensity
Contact Propensity
Answer Propensity
Dial Propensity
Trigger for additional communication
Digital Address
Physical Address
Communication Strategy

FIG. 2C is a schematic block diagram illustrating one embodiment of communication data 220. The communication data 220 may be organized as a data structure in a memory. In the depicted embodiment, the communication data 220 includes a plurality of communications 221. Each communication 221 may record an interaction between an AI agent and a contact 211. A communication 221 may be telephone call, a text message, an audio recording, a transcript of an audio recording, a text interaction, an email interaction, a video recording, a transcript of a video recording, a universal resource locator (URL) interaction and combinations thereof. Each communication 221 may comprise data that is included in but not limited to Table 3.

TABLE 3

Rang
Answered
Correct Name
Owner
Communication Strategy

FIG. 3 is a schematic block diagram illustrating one embodiment of system data 231. The system data 231 may be organized as a data structure in a memory. In the depicted embodiment, the system data 231 includes the ownership model 230, at least one AI agent 235, training data 240, the listing data 250, and messages 255.

The ownership model 230 may be trained to interact with contacts 211 in order to gather information about a property 201. The ownership model 230 may be used by a plurality of AI agents 235 to interact with the contacts 211. The ownership model 230 may be trained with the training data 240 as will be described hereafter. The ownership model 230 may also identify owners for a property 201 from the communications 221. In addition, the ownership model 230 may identify communication strategies for an individual contact 211 and/or for a group of contacts 211 from the communications 221.

The listing data 250 may store data regarding a plurality of properties 201. In addition, the listing data 250 may store contacts 211 for the properties 201. The owners and contacts 211 that are identified for a property 201 are synchronized with the listing data 250 to improve the accuracy and effectiveness of the listing data 250 as will be described hereafter. The listing data 250 may include at least one element of Table 4.

TABLE 4

New Listing Detection
Listing Update
Listing Removal
Content Validation

The messages 255 may be communicated to contacts 211. In one embodiment, the messages 255 are communicated by an AI agent 235 using the ownership model 230.

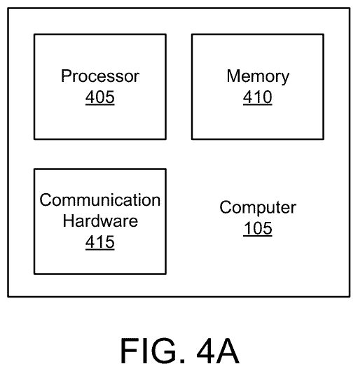

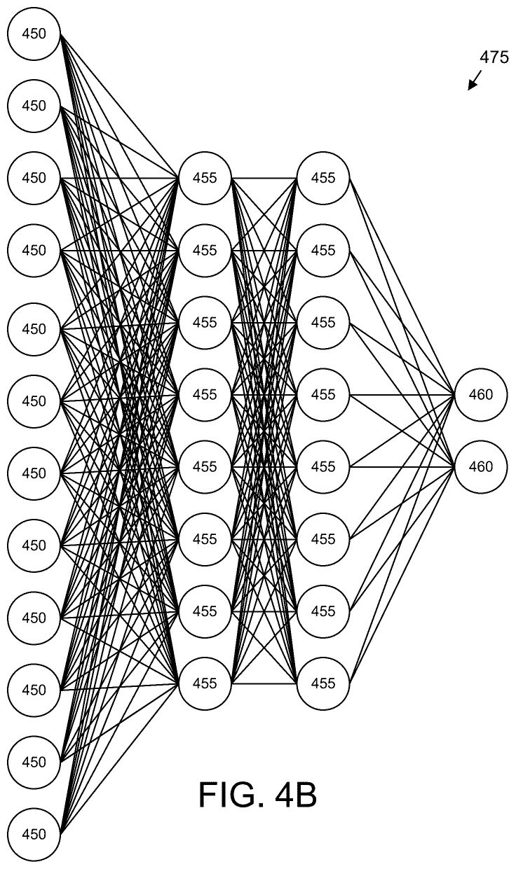

FIG. 4A is a schematic block diagram illustrating one embodiment of a computer 105. In the depicted embodiment, the computer 105 includes a processor 405, a memory 410, and communication hardware 415. The memory 410 stores code and data. The processor 405 may execute the code and process the data. The communication hardware 415 may communicate with other devices such as the network 115.

FIG. 4B is a schematic diagram illustrating one embodiment of a neural network 475. In the depicted embodiment, the neural network 475 includes input neurons 450, hidden neurons 455, and output neurons 460. The neural network 475 may be organized as a convolutional neural network, a recurrent neural network, long short term memory (LSTM) network, a transformer, and the like.

The neural network 475 may be trained with the training data 240. The training data 240 may include property data 200, contact data 210, communication data 220, and/or listing data 250. The neural network 475 may be trained using one or more learning functions while applying the training data 240 to the input neurons 450 and known result values for the output neurons 460. Subsequently, the neural network 475 may receive actual data at the input neurons 450 and make predictions at the output neurons 460 based on the actual data. The actual data may include data from the communications 221.

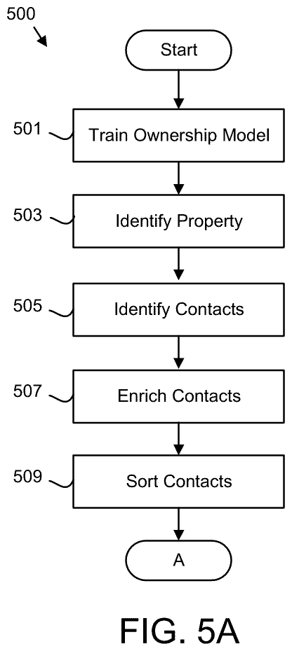

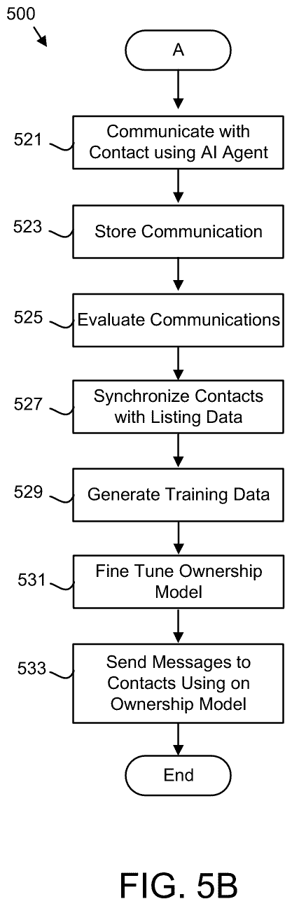

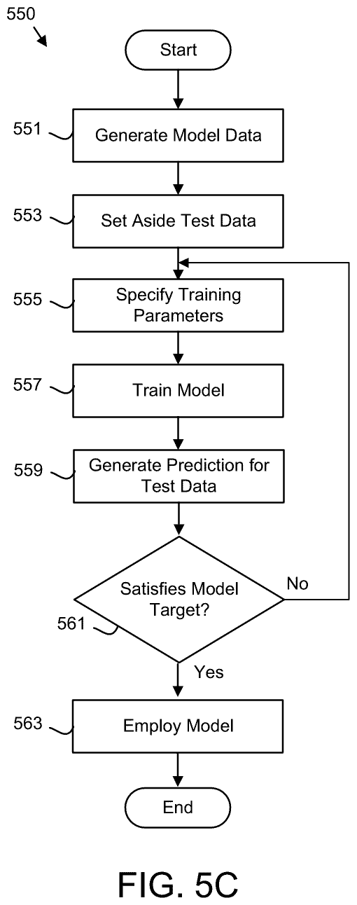

FIGS. 5A-B are schematic flow chart diagrams illustrating one embodiment of a property ownership method 500. The method 500 may enhance contacts 211 for a property 201. In addition, the method may communicate with contacts 211 in natural language for information about the contacts 211 and owners of the property 201. The owners and contacts 211 may be synchronized with the listing data 250. In addition, the method 500 may fine-tune the ownership model 230. The method 500 may be performed by the computer 105, the processor 405, and/or the neural network 475. Hereafter, the description will refer to the processor 405.

The method 500 starts, and a processor 405 trains 501 the ownership model 230. The training 501 of the ownership model 230 is described hereafter in FIG. 5C.

The processor 405 identifies 503 a property 201 for owner identification. The property 201 may be included in the listing data 250. The property 201 may be identified 503 in response to a skip trace request. Identifying 503 the property 201 may be event driven. In one embodiment, the property 201 may have insufficient owner data. In a certain embodiment, the property 201 is of interest to a client. In addition, the property 201 may be regularly identified 503 for owner identification.

The processor 405 may identify 505 at least one contact 211 for the property 201. A contact 211 may be from the listing data 250. In addition, contact 211 may be from property records for the property 201.

The processor 405 may enrich 507 the contacts 211. The contacts 211 may be enriched 507 with listing data 250. In addition, the contacts 211 may be enriched 507 from digital data 125 and/or a broker website 120. In one embodiment, digital addresses and/or physical addresses are added to the contact 211. The contacts 211 may be enriched with at least one of the elements of Table 5.

TABLE 5

Owner Propensity
Contact Propensity
Answer Propensity
Dial Propensity
Trigger for additional communication
Digital Address
Physical Address
Communication Strategy

The processor 405 may sort 509 the contacts 211. In one embodiment, the ownership model 230 is trained to give preference to contacts 211 that are likely owners. As a result, sorting 509 may float owner contacts 211 to a higher preference.

The processor 405 may communicate 521 with a contact 211 using an AI agent 235. The AI agent 235 may employ the ownership model 230. In addition, the AI agent 235 may communicate in natural language. The ownership model 230 may guide the AI agent 235 to effectively communicate with the contacts 211.

The processor 405 may store 523 the communication 221 with the contact 211. The processor 405 may evaluate 525 the communication 221 using the AI agent 235 for owners and communication strategies. In one embodiment, the communication 221 is evaluated based on at least one of the criteria of Table 6.

TABLE 6
Residential mailing address
Nonresidential mailing address
Property portfolio
Frequently occurring names
Frequently occurring communication tokens (email addresses, phone
numbers)

The ownership model 230 may identify owners based on the communication 221. In addition, the ownership model 230 may identify communication strategies for communicating with a given contact 211 and/or groups of contacts 211 based on the communication 221.

The processor 405 may synchronize 527 the owners and/or contacts 221 with the listing data 250. In one embodiment, synchronizing 527 the owners and/or contacts 221 may be subject to human approval.

The processor 405 may generate 529 training data 240 from the communications 221, the owners, and/or the communication strategies. The processor 405 may use the training data 240 to fine-tune 531 the ownership model 230.

The processor 405 may send 533 messages 255 to the contacts 221 using the ownership model 230. The ownership model 230 may direct the actions of the AI agents 235 in sending messages 255.

FIG. 5C is a schematic flow chart diagram illustrating one embodiment of a model training method 550. The method 550 may train the ownership model 230. The method 550 may be performed by the computer 105, the neural network 475, or combinations thereof.

The method 550 starts and in one embodiment, the method 550 generates 551 the training data 240. The training data 240 may be historic data. In one embodiment, real-time training data 240 is added.

The method 550 may set aside 553 a portion of the training data 240 as test data. The test data will not be used to train the ownership model 230.

The method 550 may specify 555 the training parameters. The ownership model 230 is trained 557 using the training data 240 in accordance with the training parameters.

The method 550 generates 559 a prediction from the model with the test data. The prediction may be an interaction with the contacts 211. In addition, the prediction may be a deduction from the communication 221. The method 550 determines 561 whether the prediction satisfies the target model. If the prediction does not satisfy the target model, the training parameters 275 are modified 555 and the ownership model 230 is again trained 557. If the prediction satisfies the target model, the trained ownership model 230 is employed 563 and the method 550 ends.

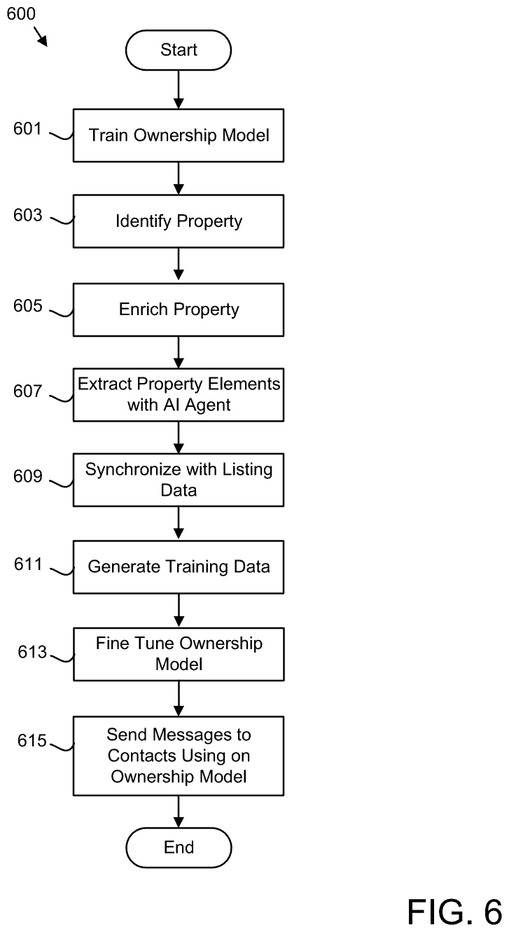

FIG. 6 is a schematic flow chart diagram illustrating one embodiment of a property element extraction method 600. The method 600 may extract and synchronize property elements with listing data 250. The method 600 may be performed by the computer 105, the processor 405, and/or the neural network 475. Hereafter, the processor 405 is referred to.

The processor 405 trains 601 the ownership model 230 as described in FIG. 5C. The processor 405 may identify 603 a property 201 from a broker website 120 and/or from digital data 125.

The processor 405 may enrich 605 the property 201. The property 201 may be enriched 605 from the listing data 250. In one embodiment, elements of the listing data 250 are added to the property 201. In addition, the property 201 may be corrected based on the listing data 250. The processor 405 may extract 607 property elements for the property 201 using the AI agent 235. The processor 405 may further synchronize 609 the property elements with the listing data 250.

In one embodiment, the processor 405 generates 611 training data 240 based on the enriched property 201. The training data 240 is used to fine-tune 613 the ownership model 230. Fine-tuning 613 improves the accuracy of the ownership model 230, so that the ownership model 230 more accurately reflects true ownership of a property 201. In addition, fine-tuning 613 improves the efficiency of the ownership model 230. In one embodiment, fine-tuning 613 enables messages 255 to be generated more rapidly from the ownership model 230. Fine-tuning 613 may also reduce the memory 410 required for the ownership model 230, reducing the cost of storing the ownership model 230. In one embodiment, fine-tuning 613 reduces the complexity of the ownership model 230. For example, fine-tuning 613 may reduce entries for a given property 201. Reducing the complexity of the ownership model 230 may reduce the cost of generating messages 255.

The processor 405 may send 615 messages 255 to the contacts 221 using the ownership model 230. The ownership model 230 may direct the actions of the AI agents 235 in sending messages 255.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of comprising:
training an ownership model;
identifying property for owner identification;
identifying contacts of property for owner identification;
enriching the contacts;
sorting the contacts;
communicating with the contacts via an artificial intelligence (AI) agent, wherein the AI agent employs the ownership model and communicates in natural language;
storing the communications with the contacts;
evaluating the communications using the AI agent for owners and communication strategies;
synchronizing the owners and contacts with listing data;
generating training data from the communications, the owners, and the communication strategies;
fine tuning the ownership model using the training data to improve the accuracy of the ownership model; and
send messages to the contacts using the ownership model.

2. The method of claim 1, wherein the communications are evaluated by the AI agent based on at least one of residential mailing address, nonresidential mailing address, property portfolio, frequently occurring names, and frequently occurring communication tokens.

3. The method of claim 1, wherein a contact comprises at least one of an owner propensity, a contact propensity, an answer propensity, a dial propensity, a trigger for additional communication, a digital address, a physical address, and a communication strategy.

4. The method of claim 1, wherein the communication comprises at least one of a rang status, an answered status, a correct name, an owner, and a communication strategy.

5. The method of claim 1, wherein the property comprises at least one of an address, a size, a lot, a jurisdiction, taxes, and a trigger for communication.

6. The method of claim 1, wherein synchronizing the contacts with listing data comprising at least one of a new listing detection, a listing update, a listing removal, and a content validation.

7. The method of claim 1, wherein synchronizing the contacts with listing data is subject to human approval.

8. The method of claim 1, wherein the property is identified in response to a skip trace request.

9. The method of claim 1, wherein the communication is selected from the group consisting of a telephone call, an email, a text message, and a universal resource locator (URL) interaction.

10. The method of claim 1, wherein identifying the property is event driven.

11. The method of claim 1, wherein property data, contract data, and communication data are organized in a Kafka system.

12. An apparatus of comprising:
a processor executing code to perform:
training an ownership model;
identifying property for owner identification;
identifying contacts of property for owner identification;
enriching the contacts;
sorting the contacts;
communicating with the contacts via an artificial intelligence (AI) agent, wherein the AI agent employs the ownership model and communicates in natural language;
storing the communications with the contacts;
evaluating the communications using the AI agent for owners and communication strategies;
synchronizing the owners and contacts with listing data;
generating training data from the communications, the owners, and the communication strategies;
fine tuning the ownership model using the training data to improve the accuracy of the ownership model; and
send messages to the contacts using the ownership model.

13. The apparatus of claim 12, wherein the communications are evaluated by the AI agent based on at least one of residential mailing address, nonresidential mailing address, property portfolio, frequently occurring names, and frequently occurring communication tokens.

14. The apparatus of claim 12, wherein a contact comprises at least one of an owner propensity, a contact propensity, an answer propensity, a dial propensity, a trigger for additional communication, a digital address, a physical address, and a communication strategy.

15. The apparatus of claim 12, wherein the communication comprises at least one of a rang status, an answered status, a correct name, an owner, and a communication strategy.

16. The apparatus of claim 12, wherein the property comprises at least one of an address, a size, a lot, a jurisdiction, taxes, and a trigger for communication.

17. The apparatus of claim 12, wherein synchronizing the contacts with listing data comprising at least one of a new listing detection, a listing update, a listing removal, and a content validation.

18. The apparatus of claim 12, wherein synchronizing the contacts with listing data is subject to human approval.

19. The apparatus of claim 12, wherein the property is identified in response to a skip trace request.

20. A computer readable program product comprising a non-transitory computer medium storing code executed by a processor to perform:
training an ownership model;
identifying property for owner identification;
identifying contacts of property for owner identification;
enriching the contacts;
sorting the contacts;
communicating with the contacts via an artificial intelligence (AI) agent, wherein the AI agent employs the ownership model and communicates in natural language;
storing the communications with the contacts;
evaluating the communications using the AI agent for owners and communication strategies;
synchronizing the owners and contacts with listing data;
generating training data from the communications, the owners, and the communication strategies;
fine tuning the ownership model using the training data to improve the accuracy of the ownership model; and
send messages to the contacts using the ownership model.
